(19) United States
(12) Patent Application Publication
(10) Pub. No.: US 2011/0206522 A1
(43) Pub. Date: Aug. 25, 2011

(54) ROTATING AIRFOIL FABRICATION UTILIZING CMC

(76) Inventors: Ioannis Alvanos, West Springfield, MA (US); Gabriel L. Suciu, Glastonbury, CT (US); Christopher M. Dye, Glastonbury, CT (US); Glenn N. Levasseur, Colchester, CT (US)

(21) Appl. No.: 12/711,297

(22) Filed: Feb. 24, 2010

(51) Int. Cl. F01D 5/30; D04H 13/00; B32B 5/12; B32B 3/02; B32B 38/00

(52) U.S. Cl. 416/204 R; 442/381; 428/114; 428/68; 156/214

(57) ABSTRACT

Disclosed is an airfoil comprising a plurality of ceramic matrix composite (CMC) fabric sheets which are layered to form a single, layered fabric sheet. The layered fabric sheet is formed so as to define a pressure and suction side of the airfoil. The airfoil includes primary fibers which extend radially outwardly from a rotor disk, for example. In this way, the airfoil is suitable for use in a gas turbine engine due to the temperature resistance of CMC and the strength provided by the primary fibers.

### BACKGROUND OF THE INVENTION

This application relates to an airfoil fabricated using a ceramic matrix composite (CMC) material. The airfoil is suitable for use in a rotor of a gas turbine engine.

Gas turbine engines typically include rotors in the turbine and compressor sections of the engine. Rotors generally include a disk and a plurality of airfoils arranged about the outer circumference of the disk. In the turbine, for example, the rotors are driven by the products of combustion. The airfoils of the turbine rotors are exposed to the products of combustion, thus they are subjected to extremely high temperatures. As the rotor is driven, the airfoils are subjected to extremely high stresses due to, for example, resistance from the fluid in the gas turbine engine. A metallic material, often a cast metal alloy such as Nickel, is typically selected for the airfoil on the basis of its capability to withstand the temperatures and stresses that airfoils are required to endure.

### SUMMARY OF THE INVENTION

In a disclosed embodiment of this invention, an airfoil is provided with an inner diameter section, an outer diameter section, and a main body portion between the inner diameter and outer diameter sections. The main body portion includes a pressure side, and a suction side opposite the pressure side. A plurality of ceramic matrix composite (CMC) fabric sheets are layered to form a layered fabric sheet. The layered fabric sheet may be formed about the inner diameter section so as to define the pressure side and the suction side of the airfoil.

Further provided is a rotor which comprises a disk and a plurality of airfoils arranged circumferentially about the disk. The plurality of airfoils each includes an inner diameter section including a root section. The inner diameter section is coupled to the disk by way of a pin extending from the disk through a cylindrical tube in the root section. The cylindrical tube and the pin each have a curved longitudinal axis. Thus, there is a relatively large contact surface area between the tubular root section and the pin.

Also put forth is a method for forming an airfoil utilizing a plurality of fabric sheets. Each fabric sheet includes a first and second fabric sheet portion, and a plurality of primary fibers continuously extending along the length thereof. A first fabric sheet is formed such that the first fabric sheet generally opposes the second fabric sheet portion. In this manner, the first and second fabric sheet portions each correspond to one of an airfoil pressure side and an airfoil suction side. A desired number of fabric sheets are wrapped about said first fabric sheet such that the primary fibers of the respective fabric sheets extend generally parallel to one another.

These and other features of the present invention can be best understood from the following specification and drawings, the following of which is a brief description.

### BRIEF DESCRIPTION OF THE DRAWINGS

FIG. 1 shows an example gas turbine engine.

FIG. 2a is a perspective view of an airfoil for a gas turbine engine.

FIG. 2b is a view of the outer diameter section of the airfoil of FIG. 2a.

FIG. 2c is a view of the inner diameter section of the airfoil of FIG. 2a.

FIG. 3a is a view of a rotor for a gas turbine engine, depicting the arrangement of the airfoils from FIG. 2a about a disk.

FIG. 3b is a view of the connection between the airfoil of FIG. 2a and the disk.

FIG. 4 is a flowchart exemplary of steps used to produce the airfoil of FIG. 2a.

FIGS. 5a-5b are representative of a method for forming, or wrapping, a fabric sheet about a tube to form the airfoil of FIG. 2a.

FIG. 5c generally depicts a method for wrapping fabric sheets about the tube in order to provide the airfoil of FIG. 2a with the desired thickness.

FIG. 5d generally depicts the layered fabric sheet and tube within a die.

FIG. 5e is a schematic representation of heat and pressure being applied to the layered fabric sheet and tube.

### DETAILED DESCRIPTION OF THE PREFERRED EMBODIMENT

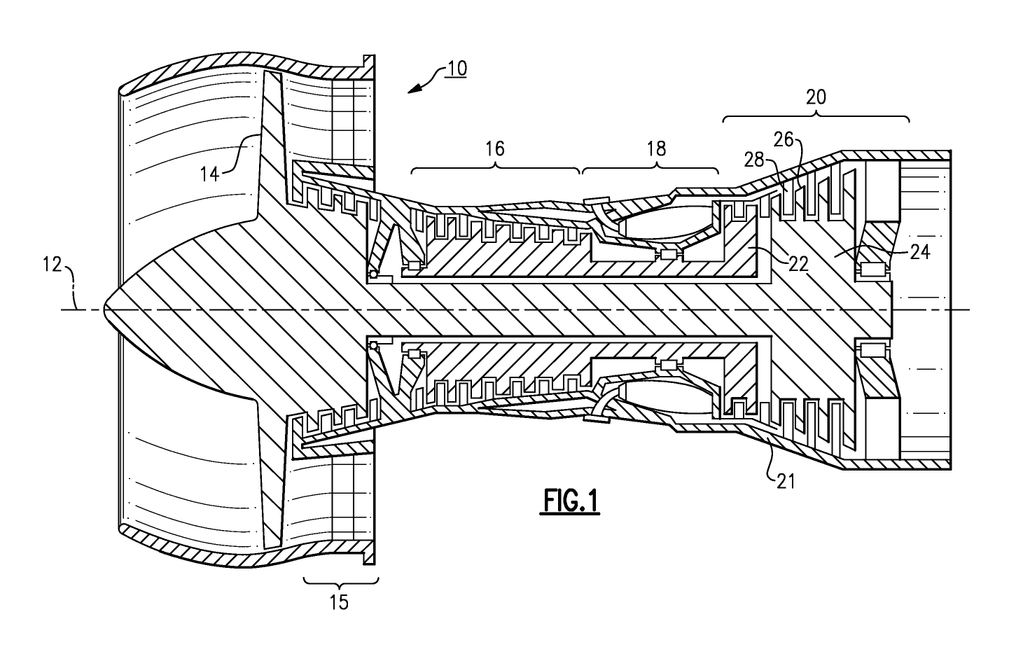

Referring to FIG. 1, a gas turbine engine 10, such as a turbofan gas turbine engine, circumferentially disposed about an engine centerline, or axial centerline axis 12, is shown. The engine 10 includes a housing 21, a fan 14, compressor sections 15 and 16, a combustion section 18 and a turbine 20. As is well known in the art, air compressed in the compressor 15/16 is mixed with fuel and burned in the combustion section 18 and expanded in turbine 20. The turbine 20 includes rotors 22 and 24, which rotate in response to the expansion. The turbine 20 comprises alternating rows of rotary airfoils or blades 26 and static airfoils or vanes 28. It should be understood that this view is included simply to provide a basic understanding of the sections in a gas turbine engine, and not to limit the invention. For example, while a fan 14 is shown, this invention may be used in turbines that do not include a fan section.

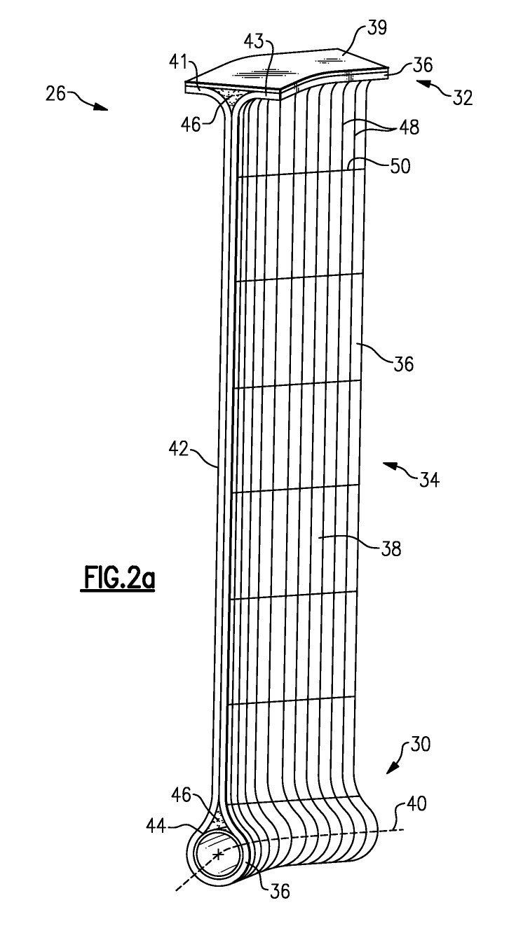

Referring to FIG. 2a, a rotary airfoil 26 is depicted. The airfoil 26 includes three sections: an inner diameter section 30, an outer diameter section 32, and a main body portion 34 extending between the inner and outer diameter sections 30, 32. The airfoil 26 is comprised of a plurality of CMC fabric sheets 37, seen in detail in FIGS. 2b-2c. Each fabric sheet 37 includes a fiber mesh consisting of primary fibers 48 and secondary fibers 50. The fibers 48 and 50 can be Silicon-Carbide fibers, for example. A CMC fabric is selected such that the primary fibers 48 extend continuously and longitudinally along (or, along the length of) each fabric sheet 37. The primary fibers 48 extend within each CMC fabric sheet 37 such that they are generally parallel to one another. To form the airfoil 26, explained in detail below, a plurality of the CMC fabric sheets 37 are formed, or wrapped, around a cylindrical tube 44. The CMC fabric sheets 37 are then layered to reach a desired thickness. A layered fabric sheet is generally represented at 36. In this manner, a single and continuous layered fabric sheet 36 can be utilized to form both a pressure side 38 and a suction side 42 of the airfoil 26. That is, one portion of the layered fabric sheet 36 is used to form one side of the airfoil 26, while the other portion of the layered fabric sheet 36 is used to form the other side of the airfoil 26. Because of the longitudinal orientation of the primary fibers 48 with respect to each fabric sheet 37, the primary fibers 48 will generally be oriented radially outwardly from the inner diameter section 30, specifically, as the primary fibers 48 extend through the main body portion 34. It should be appreciated that by layering the CMC fabric sheets 37, the primary fibers 48 of adjacent CMC fabric sheets 37 will be generally unidirectional, and will extend generally parallel to one another.

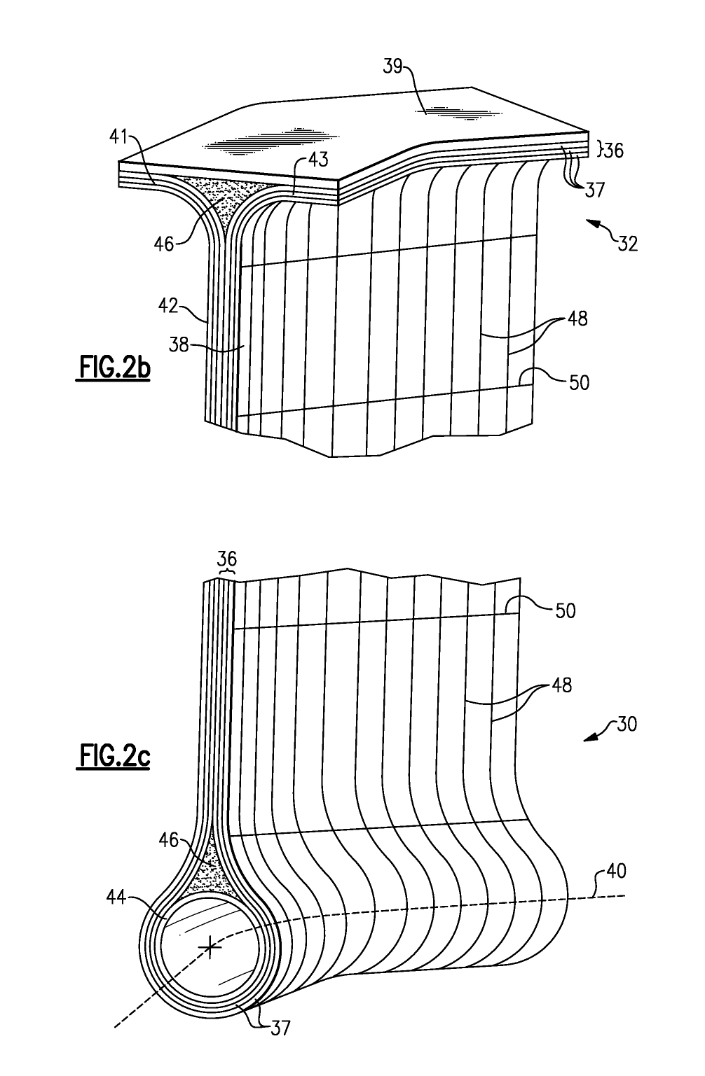

The main body portion 34 is formed to include a pressure side 38 and a suction side 42 typical of that known in the art. That is, the pressure side 38 and the suction side 42 are generally disposed on opposing sides of the axis 40. Throughout the main body portion, the primary fibers 48 extend generally perpendicular to the axis 40 of the tube 44. Viewed another way, the primary fibers 48 extend through the main body portion in a direction that is generally radially outward from the disk 25, shown in FIG. 3a.

When the airfoil 26 is rotated, it is subjected to stresses typical of a blade rotating through a fluid. The airfoil 26 is coupled to a disk 25 near the inner diameter section 30, shown in FIG. 3a. The portions of the main body portion 34 closest to the inner diameter section 30 are subjected to a relatively large concentration of stress when compared to the rest of the main body portion 34. This is, in large part, because the portion of the airfoil 26 closest to the inner diameter section 30 is required to carry the load of the remainder of the airfoil 26. By providing a layered fabric sheet 36 with the primary fibers 48 oriented in the manner described, the airfoil 26 will be extremely strong in the direction of the fibers. Thus, the airfoil 26 will generally be able to withstand the stresses which airfoils are required to endure, even the relatively large stresses concentrated near the inner diameter section 30. Further, because CMC materials are extremely temperature resistant, the usage of CMC fabric sheets 37 is, again, desirable.

Referring to FIG. 2b, the outer diameter section 32 of the airfoil 26 is shown. As shown, and as described above, a plurality of CMC fabric sheets 37 are layered to form a layered fabric sheet 36. In processing, the ends 41 and 43 of the suction side 42 and the pressure side 38, respectively, of the layered fabric sheet 36 are flattened relative to one another to form an outer diameter platform capable of accommodating an outer diameter shroud 39, if required by the application. The outer diameter shroud, or OD shroud, 39 can comprise a plurality of layers of CMC fabric. The outer diameter shroud 39 serves to increase the rigidity of the respective airfoil 26 by abutting with another outer diameter shroud 39 of a like airfoil 26, shown generally in FIG. 3a. A CMC filler material 46 is provided in voids between the pressure side 38 and the section side 42 of the layered fabric sheet 36. By providing the filler material 46, the overall rigidity of the airfoil 26 is increased.

Referring to FIG. 2c, the inner diameter, or root, section 30 is shown. In processing, explained in detail below, the CMC fabric sheets 37 may be layered around a cylindrical tube 44. The cylindrical tube 44 has a curved longitudinal axis 40. The tube 44 can be made of a metal, such as steel, for example, and can be bonded to the layered fabric sheet 36 via a resin or other known bonding agent. CMC filler material 46 is used to fill the void between the layered fabric sheet 36 and the tube 44.

Referring to FIG. 3a, a turbine rotor 24 comprising a disk 25 and a plurality of airfoils 26 arranged about the outer circumference of the disk 25 is shown. Each airfoil 26 is coupled to the disk 25 by way of a pin 54 extending from the disk and through the tube 44. The pin 54 includes a curved longitudinal axis 40 similar to that of the tube 44 such that the pin 54 is capable of extending through and engaging the tube 44. Because the longitudinal axes of the tube 44 and pin 54 are curved, the contact surface area between the tube 44 and the pin 54 is increased relative to a conventional, straight axis. This increases the reliability of the connection between the tube 44 and the pin 54 and reduces the stress that is transferred from the airfoil 26 to the disk 25. The pin 54 can be removed from the tube 44 to facilitate replacement of a damaged or worn airfoil 26.

As briefly explained above, the outer diameter shrouds 39 of respective airfoils 26 are arranged about the disk 25 such that they abut the adjacent airfoils 26. This restricts the movement of one airfoil 26 with respect to another, thus increasing the overall rigidity of the airfoils 26, and providing a more reliable rotor 24.

Referring to FIG. 3b, a connection between the airfoil 26 and the disk 25 is shown in detail. Pin 54 extends from an opening 56 in the disk 25, through the tube 44, and into an opening formed in an opposite side of the disk 25. The coupling between the pin 54 and the disk 25 accommodates for the fact that the pin 54 has a curved longitudinal axis 40. The pin 54 may be coupled to the disk 25 using other known coupling methods.

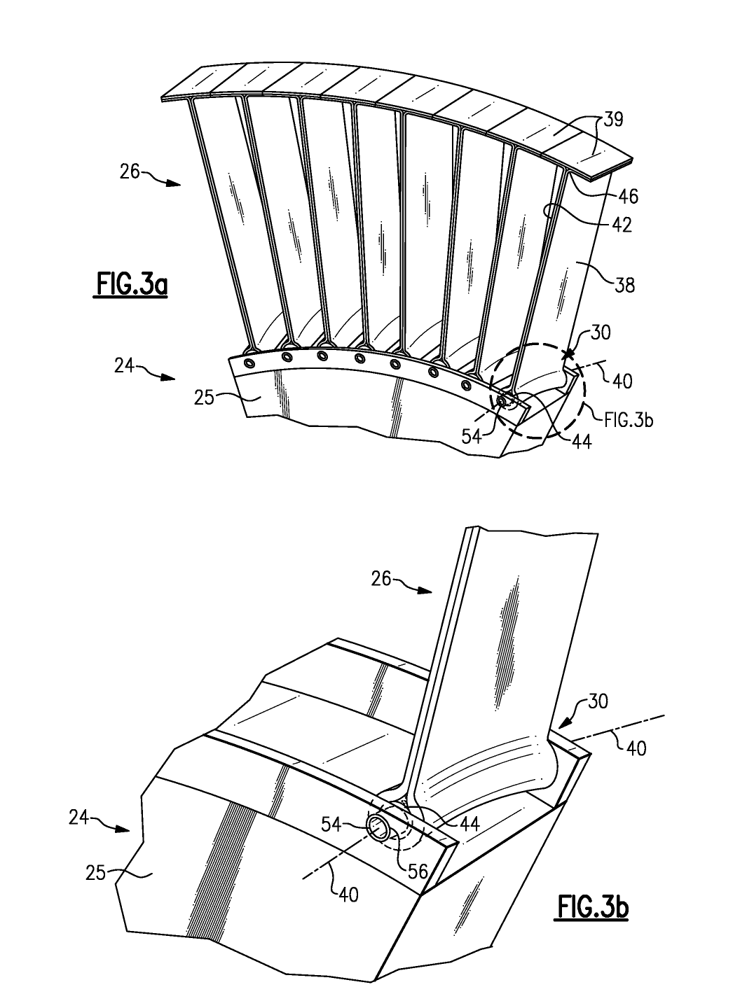

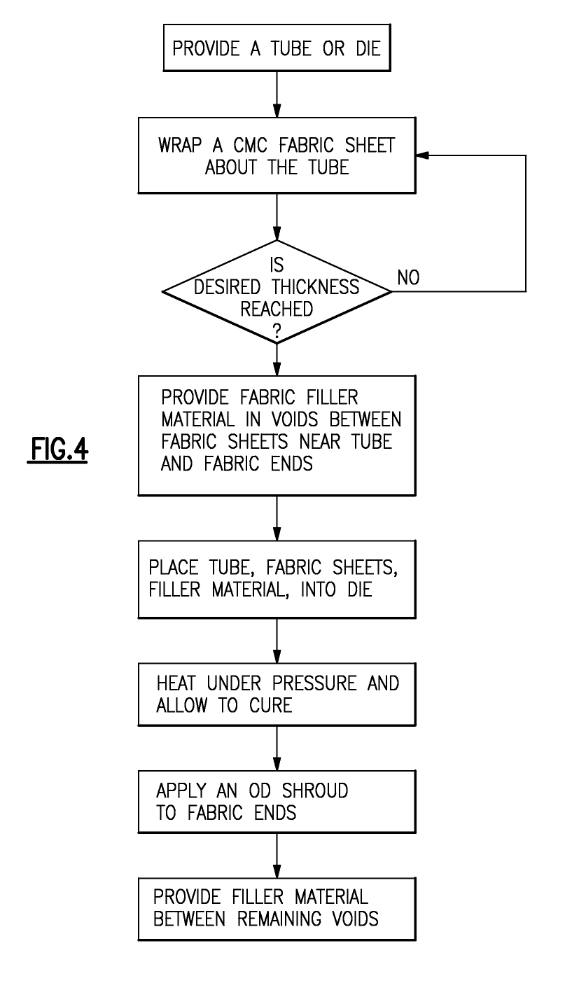

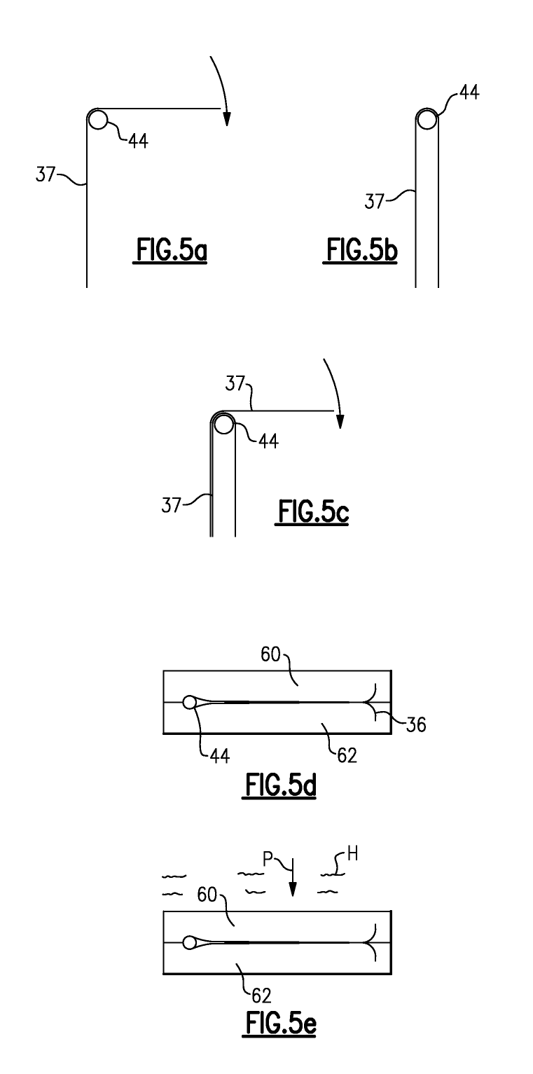

Referring to FIG. 4, a flowchart depicting a method for forming the airfoil 26 using CMC fabric sheets 37 is shown. As shown, a tube 44 can be provided. A plurality of CMC fabric sheets 37 are formed, or wrapped, around the tube 44 until a desired thickness is reached. As explained above, the CMC fabric sheets 37 are formed around the tube 44 such that the primary fibers 48 extend in a direction that is generally perpendicular to the axis 40 of the tube 44. Alternatively, a cylindrical die (with a similar axis 40) could be used in place of the tube 44. In such a case, the tube 44 would be added to the airfoil after the CMC fabric sheets 37 are layered. Whether or not a tube 44 or a cylindrical die is used, it can be said that the inner diameter portions 30 of respective CMC fabric sheets 37 are formed, or wrapped, about an axis 40 to form the layered fabric sheet 36. The process of forming, or wrapping, the CMC fabric sheets 37 is schematically represented in FIGS. 5a-5c.

CMC filler material 46 can be provided in voids between portions of the layered fabric sheet 36, and between the layered fabric sheet 36 and the tube 44. The tube 44, along with the layered fabric sheet 36 and the filler material 46, can be placed into a die, heated, pressurized and allowed to cool. This is schematically represented in FIGS. 5d-5e. By applying heat H and pressure P (seen in FIG. 5e), the layered fabric sheet 36, the filler material 46, and the tube 44 become bonded together. It will be appreciated that the use of a bonding agent or resin may be used if needed. The die can cause the ends of layered fabric sheet 36 to become flattened with respect to one another, as shown generally at ends 41 and 43. An outer diameter shroud 39 can be added to the ends 41, 43 after the layered fabric sheet 36 has been heated and pressurized, or, alternatively, it can be inserted into the die along with the layered fabric sheet 36. Again, one of ordinary skill will appreciate that known methods, including the use of a bonding agent or resin, can be used to bond the outer diameter shroud 39 to the ends 41, 43 of the layered fabric sheet 36. CMC filler material 46 can be utilized to fill in any remaining voids in the airfoil 26.

Referring to FIGS. 5a-5e, a method of forming the airfoil 26 is shown. While FIGS. 5a-5e generally correspond with the flowchart in FIG. 4, it should be appreciated that FIGS. 5a-5e are schematic representations and do not contradict the above description.

Referring to FIG. 5a, a schematic depicting a first CMC fabric sheet 37 as it is formed, or wrapped, around the tube 44 is provided. As stated above, a cylindrical die may be used in place of the tube 44.

Referring to FIG. 5b, the first CMC fabric sheet 37 from FIG. 5a is shown as fully formed, or wrapped, about the tube 44.

Referring to FIG. 5c, a representation of additional CMC fabric sheets 37 being wrapped, or layered, around the first CMC fabric sheet 37 is shown. Additional CMC fabric sheets 37 can be wrapped in this manner until a desired thickness is reached. The wrapped CMC fabric sheets 37 form the layered fabric sheet 36. As depicted, the CMC fabric sheets 37 are wrapped around the tube 44 in an upside-down orientation when compared to the orientation of the airfoil 26 shown in FIG. 2a. This accounts for the natural tendency of the CMC fabric sheets 37 to form around the tube 44 (by way of gravity), thus increasing the ease of the wrapping process.

As seen in FIG. 5d, the layered fabric sheet 36 and the tube 44 are placed into a die including upper and lower die halves 60, 62. Prior to placing the fabric sheet 36 and the tube 44 into the die, CMC filler material 46 can be provided in voids between respective portions of the layered fabric sheet 36, and between the layered fabric sheet 36 and the tube 44. By providing filler material 46, as shown in FIGS. 2a-2c, formation of the airfoil 26 is assisted. That is, the die halves 60, 62 define the shape of the exterior of the airfoil 26, while the filler material 46 supports the interior of the airfoil 26.

The die halves 60, 62 are configured to mirror the form of the airfoil 26, generally depicted in FIG. 2a. Specifically, one of the die halves 60, 62 corresponds to the pressure side 38 and the other corresponds to the suction side 42 of the airfoil 26.

As seen in FIG. 5e, the layered fabric sheet 36 and the tube 44 are treated with heat H and pressure P. The heat H and pressure P treatment causes the layered fabric sheet 36, the tube 44, the filler material 46 (if present), and the outer diameter shroud 39 (if present) to bond with one another. The layered fabric sheet 36 takes the form of the die halves 60, 62, and thus the layered fabric sheet 36 takes the general form of the airfoil 26.

Various CMC materials, such as Carbon, Silicon-Carbide, or Alumina based composites, etc., are sold commercially and can be selected for use herein. Depending on operating conditions, one can select an appropriate CMC material for use in the described fabric sheets, filler material, and outer diameter shroud.

As will be appreciated, the use of CMC materials will allow an increase in the temperature at which the engine can be operated, and can even eliminate the need for some cooling fluids. Further, use of CMC materials in place of the metal alloys will result in significant weight saving.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An airfoil comprising:
an inner diameter section;
an outer diameter section opposite the inner diameter section;
a main body portion between the inner diameter and outer diameter sections;
wherein a plurality of ceramic matrix composite fabric sheets are layered to form a layered fabric sheet, and the layered fabric sheet is formed about the inner diameter section so as to define a pressure side and a suction side of the airfoil.

2. The airfoil of claim 1 wherein each of the plurality of fabric sheets includes at least two primary fibers arranged in a fiber mesh, the primary fibers continuously extending from the inner diameter section to the outer diameter section.

3. The airfoil of claim 2 wherein the fabric sheets are layered such that the primary fibers of respective fabric sheets extend in substantially the same direction.

4. The airfoil of claim 2 further including that the primary fibers are generally parallel to one another.

5. The airfoil of claim 2 further including that the primary fibers extend through the main body portion in a direction that is generally perpendicular to an axis of the inner diameter section, the layered fabric sheet being formed about the axis.

6. The airfoil of claim 2 wherein the fiber mesh includes a plurality of secondary fibers oriented generally perpendicular to the primary fibers.

7. The airfoil of claim 2 wherein the inner diameter section is capable of being coupled to a disk, and the primary fibers are unidirectional and will generally extend radially outwardly from the disk.

8. The airfoil of claim 1 wherein an outer surface of the outer diameter section forms an outer diameter platform.

9. The airfoil of claim 8 wherein the outer diameter platform is covered by an outer diameter shroud, the outer diameter shroud being made of a ceramic matrix composite.

10. A rotor for use in a turbine or compressor comprising:
a disk rotatable about an axis;
a plurality of airfoils arranged circumferentially about the disk;
wherein the plurality of airfoils each include an inner diameter section including a root section; and
wherein the inner diameter section is coupled to the disk by way of a pin extending from the disk through a cylindrical tube in the root section, each of the cylindrical tube and the pin having a curved longitudinal axis.

11. The rotor of claim 10 wherein the plurality of airfoils each include a layered fabric sheet defining the root section, a pressure side, and a suction side thereof.

12. A method of forming an airfoil comprising the steps of:
a) providing a plurality of fabric sheets, each fabric sheet including a first and second fabric sheet portion, and each fabric sheet including a plurality of primary fibers continuously extending along the length thereof;
b) forming a first fabric sheet such that a first fabric sheet portion of the first fabric sheet generally opposes a second fabric sheet portion of the first fabric sheet, the first and second fabric sheet portions each corresponding to one of an airfoil pressure side and an airfoil suction side;
c) wrapping a desired number of fabric sheets about said first fabric sheet such that the primary fibers of the respective fabric sheets extend generally parallel to one another.

13. The method of claim 12 wherein after step (c):
d) providing a filler material within a void between the fabric sheets near the axis, and providing a filler material between the ends of the first and second fabric sheet portions.

14. The method of claim 12 wherein after step (c):
e) applying an outer diameter shroud between the ends of the first and second fabric sheet portions.
